(19) United States
(12) Patent Application Publication
(10) Pub. No.: US 2006/0224652 A1
(43) Pub. Date: Oct. 5, 2006

(54) Instruction set processor enhancement for computing a fast fourier transform

(75) Inventors: Kim Rounioja, Oulu (FI); Sien An Ong, Roermond (NL)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/100,084

(22) Filed: Apr. 5, 2005

(51) Int. Cl. G06F 17/14

(52) U.S. Cl. 708/404

(57) ABSTRACT

This invention describes a method of computing a fast Fourier transform (FFT) using enhanced processor computational capabilities for more efficient and flexible implementation of an electronic device (e.g., a linear equalizer) based on that FFT computing. A simple non-parallel instruction set processor (or just a non-parallel processor) containing complex multiplication and addition/subtraction capabilities is extended by adding additional registers and interconnects and a dedicated parallel instruction for calculating the FFT butterfly. The parallel instruction consists of orthogonal sub-instructions each controlling a section of the data path related to a corresponding section of the FFT butterfly.

### TECHNICAL FIELD

This invention relates to computing fast Fourier transform (FFT) and more specifically to efficient and flexible implementation of an electronic device (e.g., a linear equalizer) based on that FFT computing.

### BACKGROUND ART

Solving taps of a WCDMA (wideband code-division multiple access) linear equalizer is a computationally complex problem. Frequently, the tap solution algorithm is based on computing fast Fourier transform (FFT). Because the FFT is a basic operation in signal processing, support for the FFT in processors is a well-studied and established topic. Many signal processors include an instruction set level support for computing the FFT. Typically, the support is provided for the bit-reversed addressing mode.

In one option, the FFT may be computed using a constant geometry architecture (CGA) and the decimation-in-time principle. The signal flow graph of a 32-point FFT with the CGA is shown in FIG. 1 containing input samples 11 and butterflies 10. The butterflies 10 are represented by rectangles and a (horizontal) row of butterflies is referred to as a stage. There are 5 stages 10-1, 10-2, 10-3, 10-4 and 10-5 in the example of FIG. 1. Each stage 10-1, 10-2, 10-3, 10-4 or 10-5 contains 16 butterflies and each butterfly 10 has inputs from two input samples 11 out of 32 input samples preceding said each stage 10-1, 10-2, 10-3, 10-4 or 10-5. The butterfly operations are executed row-by-row.

Thus, the FFT consists of operations called “FFT butterflies”. Assuming CGA for the FFT, the Radix-2 decimation-in-time butterfly consists of the following pair of (complex arithmetic) equations for calculating first and second output terms X₀ and X₁, respectively:

$$\{ \begin{matrix}{X}_{0} = {x}_{0} + tf \cdot {x}_{1} \\ {X}_{1} = {x}_{0} - tf \cdot {x}_{1}\end{matrix} ,$$

wherein tf is a twiddle factor (or an FFT twiddle factor), x₁ and x₀ are first and second input terms, respectively. A total of one complex multiplication, one complex addition, one complex subtraction, three memory loads and two memory stores are needed per one butterfly.

Some processors support the FFT butterfly computation by adding a dedicated computation unit for that purpose. Some processors include additional functionality, which implements part of the FFT butterfly computation, e.g., U.S. Pat. No. 5,941,940, “Digital Signal Processor Architecture Optimized for Performing Fast Fourier Transforms”, by M. K. Pasad et al. describes an architecture with two MAC units with a crossover in outputs. Also so-called dedicated FFT processors can execute the FFT very efficiently, but have very limited capabilities for any other use.

### DISCLOSURE OF THE INVENTION

The object of the present invention is to provide a methodology of computing fast Fourier transform (FFT) using enhanced processor computational capabilities for more efficient and flexible implementation of an electronic device (e.g., a linear equalizer) based on that FFT computing.

According to a first aspect of the invention, a method for enhancing computational capabilities of a processor having complex multiplication and addition/subtraction capabilities for computing a fast Fourier transform, comprises the steps of: adding at least one further register and at least one further interconnect to the processor for performing FFT butterfly computing of the fast Fourier transform; and adding a parallel instruction to the processor utilizing the at least one further register and the at least one further interconnect for the computing of the FFT butterfly, thus enhancing the computational capabilities of the processor, wherein the processor is not dedicated to only the computing of the fast Fourier transform.

According further to the first aspect of the invention, the processor may be a non-parallel processor.

Further according to the first aspect of the invention, the processor may be a parallel processor.

Still further according to the first aspect of the invention, the FFT butterfly may be for calculating first and second output terms X₀ and X₁, respectively, described by equations with complex terms:

$$\{ \begin{matrix}{X}_{0} = {x}_{0} + tf \cdot {x}_{1} \\ {X}_{1} = {x}_{0} - tf \cdot {x}_{1}\end{matrix} ,$$

wherein tf is a twiddle factor, x₁ and x₀ are first and second input terms, respectively, and wherein the twiddle factor tf, the first input term x₁ or the second input term x₀ may be loaded to the non-parallel processor using the at least one further register. Still further, at least one sub-instruction of the parallel instruction may be used for loading the first input term x₁ to the processor and updating a register with the first input term x₁, optionally using the at least one further register. Yet still further, at least one sub-instruction of the parallel instruction may be used for loading the twiddle factor tf to the processor and updating a register with the twiddle factor tf, optionally using the at least one further register. Still yet further, at least one sub-instruction of the parallel instruction may be used for loading the second input term x₀ to the processor and updating a register with the second input term x₀, optionally using the at least one further register.

According further to the first aspect of the invention, at least one sub-instruction of the parallel instruction may be used for a complex multiplication of the twiddle factor tf and the first input term x₁ using the multiplication capabilities, thus generating a multiplication value. Further, at least one further sub-instruction of the parallel instruction may be used for shifting and truncating the multiplication value or the multiplication capabilities may automatically include the shifting and truncating, thus generating an adjusted multiplication value, and updating a register with the adjusted multiplication value, optionally using the at least one further register. Still further, at least one still further sub-instruction of the parallel instruction may be used for a complex addition of the adjusted multiplication value and the second term for generating the first output terms X₀ and used for complex subtraction of the adjusted multiplication value from the second term for generating the second output terms X₁ using the complex addition/subtraction capabilities.

According still further to the first aspect of the invention, at least one yet further sub-instruction of the parallel instruction may be used for storing the first and second output terms X₀ and X₁, and for updating registers with the first and second output terms X₀ and X₁, respectively, optionally using the at least one further register. Further, before the adding the parallel instruction, the method may further comprise: adding at least one address register and a corresponding at least one address computation unit to the processor for accessing in a corresponding memory the first input term x₀, the second input term x₁, the twiddle factor tf, the first output term X₀ or the second output terms X₁ during the computing of the fast Fourier transform.

According to a second aspect of the invention, a computer program product comprises: a computer readable storage structure embodying computer program code thereon for execution by a computer processor with the computer program code characterized in that it includes instructions for performing the steps of the first aspect of the invention as being performed by the processor or contained in the parallel instruction provided to the processor.

According to a third aspect of the invention, a processor, having complex multiplication and addition/subtraction capabilities and having enhanced computational capabilities for computing a fast Fourier transform, is characterized in that the enhanced computational capabilities comprise: at least one further register and at least one further interconnect, for performing FFT butterfly computing of the fast Fourier transform; and a parallel instruction utilizing the at least one further register and the at least one further interconnect for the computing of the FFT butterfly, thus enhancing the computational capabilities of the processor, wherein the processor is not dedicated to only the computing of the fast Fourier transform.

According further to the third aspect of the invention, the processor may be a non-parallel processor.

Further according to the third aspect of the invention, the processor may be a parallel processor.

Still further according to the third aspect of the invention, the FFT butterfly may be for calculating first and second output terms X₀ and X₁, respectively, described by equations with complex terms:

$$\{ \begin{matrix}{X}_{0} = {x}_{0} + tf \cdot {x}_{1} \\ {X}_{1} = {x}_{0} - tf \cdot {x}_{1}\end{matrix} ,$$

wherein tf is a twiddle factor, x₁ and x₀ are first and second input terms, respectively, and wherein the twiddle factor tf, the first input term x₁ or the second input term x₀ is loaded to the processor using the at least one further register. Further, at least one sub-instruction of the parallel instruction may be used for loading the first input term x₁ to the processor and updating a register with the first input term x₁, optionally using the at least one further register. Still further, at least one sub-instruction of the parallel instruction may be used for loading the twiddle factor tf to the processor and updating a register with the twiddle factor tf, optionally using the at least one further register. Yet still further, at least one sub-instruction of the parallel instruction may be used for loading the second input term x₀ to the processor and updating a register with the second input term x₀, optionally using the at least one further register.

According further to the third aspect of the invention, at least one sub-instruction of the parallel instruction may be used for a complex multiplication of the twiddle factor tf and the first input term x₁ using the multiplication capabilities, thus generating a multiplication value. Further, at least one further sub-instruction of the parallel instruction may be used for shifting and truncating the multiplication value or the multiplication capabilities may automatically include the shifting and truncating, thus generating an adjusted multiplication value, and updating a register with the adjusted multiplication value, optionally using the at least one further register. Still further, at least one still further sub-instruction of the parallel instruction may be used for a complex addition of the adjusted multiplication value and the second term for generating the first output terms X₀ and used for complex subtraction of the adjusted multiplication value from the second term for generating the second output terms X₁ using the complex addition/subtraction capabilities.

According still further to the third aspect of the invention, the at least one yet further sub-instruction of the parallel instruction may be used for storing the first and second output terms X₀ and X₁, and for updating registers with the first and second output terms X₀ and X₁, respectively, optionally using the at least one further register. Further, the enhanced computational capabilities may further comprise: at least one address register and a corresponding at least one address computation unit, for accessing in a corresponding memory the first input term x₀, the second input term x₁, the twiddle factor tf, the first output term X₀ or the second output terms X₁ during the computing of the fast Fourier transform.

According to a fourth aspect of the invention, an electronic device having a processor containing complex multiplication and addition/subtraction capabilities and enhanced computational capabilities for computing a fast Fourier transform, is characterized in that the enhanced computational capabilities may comprise: at least one further register and at least one further interconnect, for performing FFT butterfly computing of the fast Fourier transform; and a parallel instruction utilizing the at least one further register and the at least one further interconnect for the computing of the FFT butterfly, thus enhancing the computational capabilities of the processor, wherein the processor is not dedicated to only the computing of the fast Fourier transform. Further, the processor may be a non-parallel processor or a parallel processor.

The invention allows efficient and flexible implementation, e.g., of the FFT based linear equalizer in a simple processor. The FFT algorithm can be scheduled efficiently using the dedicated parallel instruction.

The provided flexibility can be considered important, because it allows
allocating the rest of the equalizer algorithm to the same processor, not just the FFT part;
significant late changes in the algorithm;
late recovery of design errors in the algorithm; and
allocating other algorithms to the same processor.

The efficiency is characterized as follows. The parallel instruction allows the computation of the FFT butterfly with only 2 cycles (throughput). A similar performance would typically be obtained only from a much more dedicated hardware architecture. A typical digital signal processor uses 5 cycles/butterfly. A typical generic purpose processor uses >10 cycles/butterfly. Due to the parallel instruction enabling pipelining of the butterfly computation, very high clock rates can be reached. When coupled with the CGA FFT, a high efficiency can be reached as well.

### BRIEF DESCRIPTION OF THE DRAWINGS

For a better understanding of the nature and objects of the present invention, reference is made to the following detailed description taken in conjunction with the following drawings, in which:

FIG. 1 is a flow graph of a 32-point constant geometry architecture (CGA) fast Fourier transform (FFT);

FIG. 2a is a block diagram of a data path of a simple non-parallel processor for complex arithmetic computation, according to the prior art;

FIG. 2b is a block diagram of a data path of a simple non-parallel processor for complex arithmetic computation showing memory access and address generation, according to the prior art;

FIG. 3a is a block diagram of an enhanced data path for FFT butterfly computing using a non-parallel processor with additional registers and interconnects, according to the present invention;

FIG. 3b is a block diagram of an enhanced data path for FFT butterfly computing using a non-parallel processor with additional registers and interconnects and showing memory access and address generation components, according to the present invention; and

FIG. 4 is a block diagram of an enhanced data path for FFT butterfly computing using a non-parallel processor with additional registers and interconnects, and with selected data path sections for orthogonal sub-instructions of a parallel instruction, according to the present invention.

### BEST MODE FOR CARRYING OUT THE INVENTION

The present invention provides a new methodology of computing a fast Fourier transform (FFT) using enhanced processor computational capabilities for more efficient and flexible implementation of an electronic device (e.g., a linear equalizer) based on that FFT computing. The present invention can be used for, e.g., implementing of a chip equalizer detector for a WCDMA (wideband code-division multiple access) receiver and can be extended to a plurality of other applications utilizing the FFT.

According to the present invention, a simple processor (it can be a non-parallel processor or a parallel processor) containing complex multiplication and addition/subtraction capabilities can be extended by adding additional registers and interconnects and a dedicated parallel instruction for calculating the FFT butterfly as described in detail below. The parallel instruction consists of orthogonal sub-instructions each controlling a section of the data path related to a corresponding section of the FFT butterfly. Partitioning to the sub-instructions is selected such, that an FFT algorithm of an arbitrary length can be scheduled efficiently by utilizing the parallel instruction. The parameters of each sub-instruction are restricted in such a way, that the instruction word size is not increased.

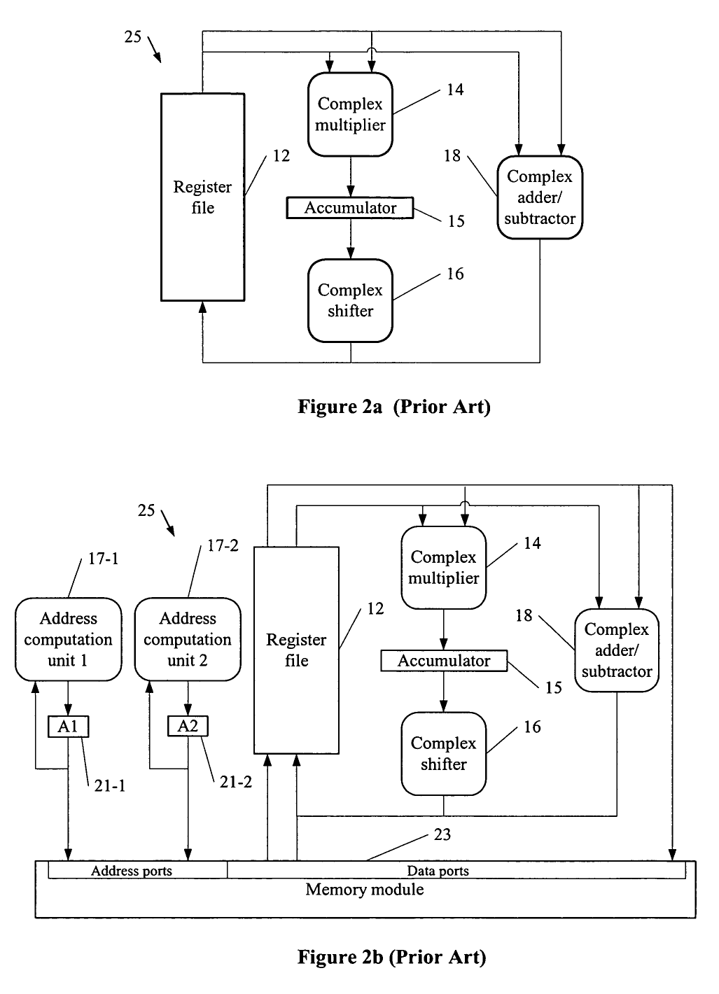

FIG. 2a shows one example among others of a block diagram of a data path of a simple non-parallel processor 25 (e.g., a processor with k-bit data word) for complex arithmetic computation including complex multiplication and addition/subtraction, according to the prior art. Typical well-known components of the prior art processor 25 of FIG. 2a include a register file 12, a complex multiplier 14, an accumulator 15, a complex shifter 16 and a complex adder/subtractor 18.

The blocks 15 and 16 are for shifting and truncating of a multiplication value generated by the complex multiplier 14. The complex (fixed-point) multiplier 14 generates the output that has a wordlength twice that of the operands. E.g., with a k-bit processor, if the operands are k bits wide, then the multiplication value is 2 k bits wide. The shifting and truncating is used to select the relevant k bits (e.g., the k most significant bits) of the multiplication result for further processing.

The block 15 (accumulator) is a complex register dedicated to containing the result of a fixed-point complex multiplication. This register 15 is (typically) wide enough to contain the full untruncated (e.g., 2 k bits wide) multiplication value, meaning that it has in general twice the wordlength compared to other registers used in the processor 25. The block 16 is a complex shifter unit, which is used to select the relevant part of the multiplication value (e.g., the k most significant bits) thus generating an adjusted multiplication value.

According to the prior art, if the processor 25 is a floating point processor, the functionality implemented by the blocks 15 and 16 would be effectively contained in the complex multiplier 14, which means that the accumulator 15 and the complex shifter 16 are not present in FIG. 2a (similar considerations in that regard are applied to FIGS. 2b, 3a, 3b and 4 discusses below).

FIG. 2b is an extension of FIG. 2a showing, per the prior art, one example among others of the same non-linear processor 25, but emphasizing more details, specifically showing memory access and address generation blocks including memory module 23, address computation units 17-1 and 17-2, and address registers 21-1 and 21-2. Typically, the non-parallel processor 25 can have one or two address registers with corresponding one or two address computation units.

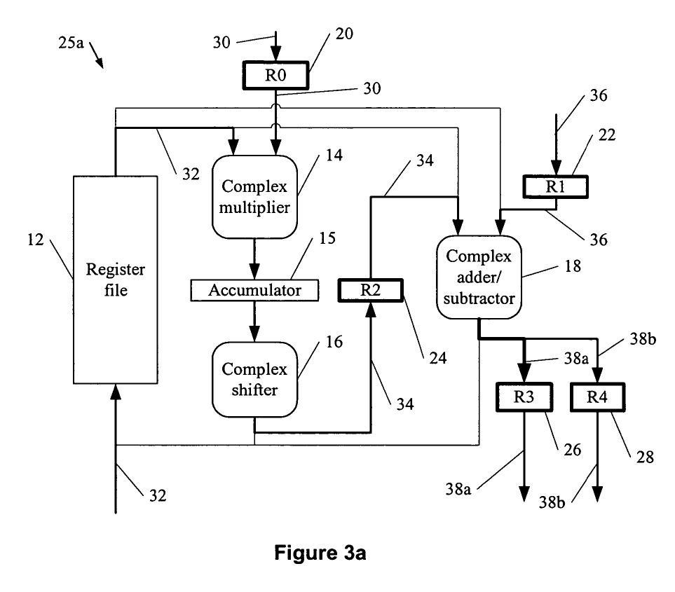

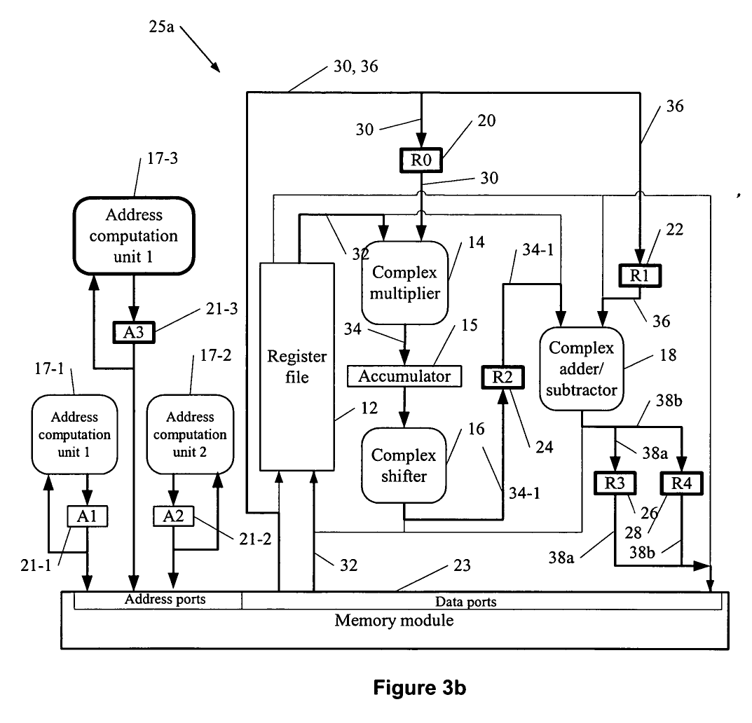

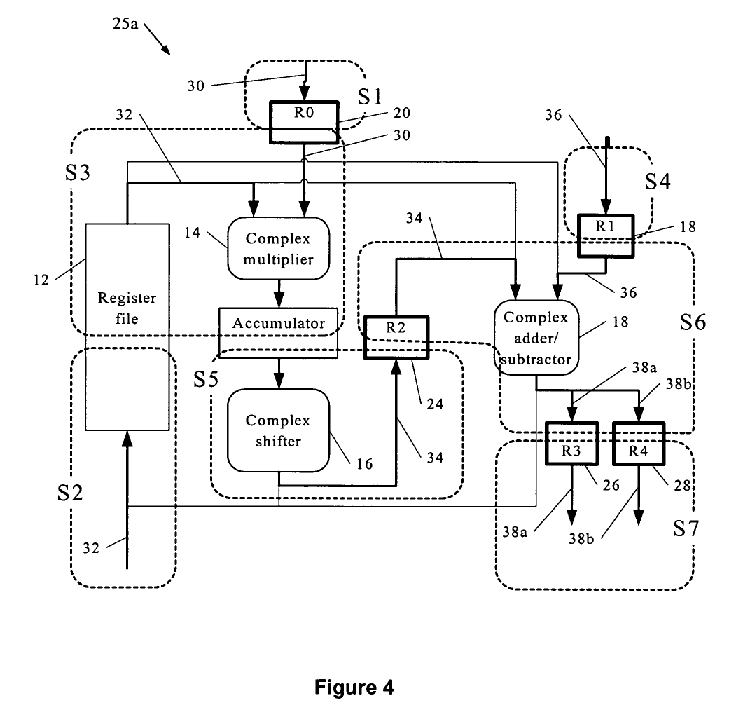

A simple non-parallel processor 25 illustrated in FIGS. 2a and 2b is extended, according to the present invention, by adding additional registers and interconnects (hardware) and the dedicated parallel instruction for calculating the FFT butterfly. FIGS. 3a and 3b demonstrate this extension for adding hardware components (registers, interconnects, etc.) and FIG. 4 demonstrates further adding of the dedicated parallel instruction.

FIG. 3a shows one example among others of a block diagram of an enhanced data path for the FFT butterfly computing by converting the non-parallel (original) processor 25 of FIG. 2a to a modified non-parallel processor 25a with additional registers and interconnects shown in FIG. 3a, according to the present invention.

Adding the registers and interconnects to the original processor 25 allows to use existing elements for the data path implementing the FFT butterfly. The data path is constructed in such a way that it only uses the computation elements already existing in the original processor 25, thus minimizing the added cost.

As seen from FIG. 3a, a register 20 (R0) and an interconnect line 30 are added for loading the first input term x₁ to said non-parallel processor 25a (i.e., to the complex multiplier 14), wherein the register 20 is updated with said first input term x₁. Moreover, a register 22 (R1) and an interconnect line 36 are added for loading the second input term x₀ to said non-parallel processor 25a (i.e., to the complex adder/subtractor 18), wherein the register 22 is updated with said first input term x₀. Furthermore, a pre-existing interconnect line 32 is used for loading the twiddle factor tf to said non-parallel processor 25a (i.e., to the complex multiplier 14), wherein the pre-existing file register 12 is updated with twiddle factor tf.

Still further, a register 24 (R2) and an interconnect line 34 are added for loading the adjusted multiplication value to the complex adder/subtractor 18, wherein the register 24 is updated with the adjusted multiplication value. As it was pointed out above, the adjusted multiplication value can be generated by the complex shifter 16 or alternatively it can be generated internally by the complex multiplier 14 in case of the floating point processing (as discussed above in regard to FIG. 2a).

Finally, registers 26 (R3) and 28 (R4) and corresponding interconnect lines 38a and 38b are added for facilitating storing the first and second output terms X₀ and X₁, respectively, wherein the registers 26 and 28 are updated with the said first and second output terms X₀ and X₁, respectively. In an alternative implementation, according to the present invention, one register (instead of the two registers 26 and 28) can be used for both terms X₀ and X₁ (e.g., depending on latencies of blocks 14 and 18) or said one register can be just time-division-multiplexed to contain either X₀ or X₁ at one time.

FIG. 3b is an extension of FIG. 3a showing, according to the present invention, one example among others of the same non-linear processor 25a, but emphasizing more details, specifically showing memory access and address generation blocks, similar to FIG. 2b. The prior art address computation units 17-1 and 17-2, and address registers 21-1 and 21-2 (typically, the prior art non-parallel processor 25 can have one or two address registers with corresponding one or two address computation units, as mentioned above) cannot support all needed parameters of the FFT butterfly in FIG. 3b. E.g., the address register 21-1 can provide updating the addresses as a part of access to the memory module 23 for loading the input terms x₁ and x₀ to the corresponding blocks of the processor 25a as discussed above in regard to FIG. 3a (alternatively, it can be two address registers: one for x₁ and another one for x₀, as pointed out above). Similarly, the address register 21-2 can provide, e.g., updating the address as a part of access to the memory module 23 for loading the twiddle factor tf to the corresponding block of the processor 25a as discussed above in regard to FIG. 3a. Then, according to the present invention, at least one more address register 21-3 and a corresponding at least one address computation unit 17-3 are added to said processor 25a, e.g., for updating the addresses as a part of access to the memory module 23 for accessing said first and second output terms X₀ and X₁ during said computing of said fast Fourier transform (alternatively, it can be two address registers: one for X₀ and another one for X₁).

The memory module 23, as shown in FIG. 3b, is a multi-port memory for storing all parameters (x₀, x₁, tf, X₀ and X₁) for computing the FFT butterfly. In an alternative implementation, according to the present invention, the memory can consists of separate blocks: e.g., an input stage memory for storing x₀ and x₁, a memory for twiddle coefficients, an output stage memory for storing X₀ and X₁. These independent block memories are then independently connected to the corresponding address registers 21-1, 21-2 and 213 and address computation units 17-1, 17-2 and 17-3.

FIG. 4 shows one example among others of a block diagram of an enhanced data path for the FFT butterfly computing using a modified non-parallel processor 25a with additional registers and interconnects, and with selected data path sections for orthogonal sub-instructions of a parallel instruction, according to the present invention. The parallel instruction is added to the instruction set of the non-parallel processor for controlling the enhanced data path. The parallel instruction is constructed of several orthogonal sub-instructions, which implement the various parts of the FFT butterfly. An example of such construction is illustrated in FIG. 4, where the FFT butterfly operation is composed of sub-instructions S1-S7 as follows:

S1: load the first input term x₁ of the FFT butterfly and update the address register (e.g., the address register 21-1);

S2: load the FFT twiddle coefficient tf and update the address register (e.g., the address register 17-2);

S3: multiply the first input term x₁ and the twiddle coefficient tf thus generating the multiplication value (complex);

S4: load the first input term x₀ of the FFT butterfly and update the address register (e.g., the address register 17-2);

S5: shift and truncate the multiplication value (generating the adjusted multiplication value);

S6: perform the complex addition and subtraction between the adjusted multiplication value and the second input term, generating the first and the second output terms X₀ and X₁, respectively; and

S7: store the butterfly output terms X₀ and X₁ and update the address register (e.g., the address register 17-3).

According to the present invention, the sub-instructions are selected orthogonal such, that efficient scheduling of the FFT algorithm is possible. When coupled with the CGA FFT algorithm, the FFT of an arbitrary length (meaning length=2^{k}, k=1,2, . . . ) can be implemented in the processor software.

Because the instruction parameters can be restricted according to the application, the width of the instruction word is not increased, even if a significant instruction level parallelism is provided for the FFT computation. The processor architecture remains simple, while the efficiency of the FFT algorithm is increased.

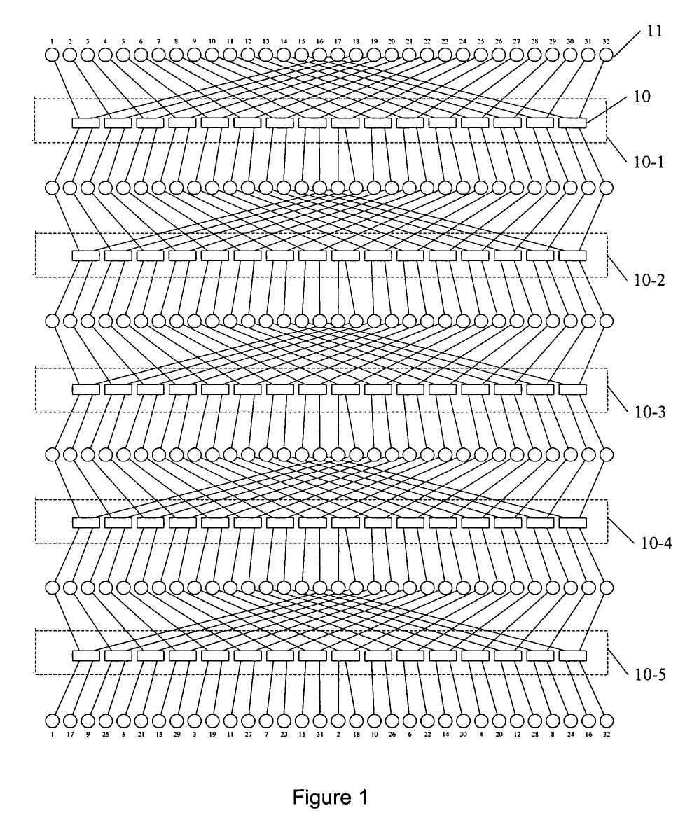

The constant geometry architecture FFT algorithm of FIG. 1 can be implemented using the parallel instruction as shown in the pseudo-code below:

FFT_CGA_routine is {

declare address pointers: tw, x1, x2, y
for (“every stage in FFT”) {

for (“all BFs within stage”) {

fft_butterfly(tw, x1, x2, y);

}
“swap x and y pointers”

}
“re-order result vector”

}

The innermost loop (bolded above) consists of multiple FFT butterfly operations. The orthogonal sub-instructions provide the capability to schedule the whole innermost loop, including the loop prolog and epilog, by using only the parallel instruction. This is done by normal software pipelining technique as used in VLIW (very large instruction word) type of processors.

It is noted that the block diagrams presented in FIGS. 2a, 2b, 3a, 3b and 4 use a simple non-parallel processor 25 as an example, but according to the present invention, the methodology described in this invention can be applied to the parallel processors as well, e.g., to the parallel processors based on single-instruction-multiple-data principle (SIMD).

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method for enhancing computational capabilities of a processor having complex multiplication and addition/subtraction capabilities for computing a fast Fourier transform, comprising the steps of:
adding at least one further register and at least one further interconnect to said processor for performing FFT butterfly computing of said fast Fourier transform; and
adding a parallel instruction to said processor utilizing said at least one further register and said at least one further interconnect for said computing of said FFT butterfly, thus enhancing said computational capabilities of said processor,
wherein said processor is not dedicated to only said computing of said fast Fourier transform.

2. The method of claim 1, wherein said processor is a non-parallel processor.

3. The method of claim 1, wherein said processor is a parallel processor.

4. The method of claim 1, wherein said FFT butterfly is for calculating first and second output terms X₀ and X₁, respectively, described by equations with complex terms:
$$\{ \begin{matrix}{X}_{0} = {x}_{0} + tf \cdot {x}_{1} \\ {X}_{1} = {x}_{0} - tf \cdot {x}_{1}\end{matrix} ,$$
wherein tf is a twiddle factor, x₁ and x₀ are first and second input terms, respectively, and wherein said twiddle factor tf, said first input term x₁ or said second input term x₀ is loaded to said non-parallel processor using said at least one further register.

5. The method of claim 4, wherein at least one sub-instruction of said parallel instruction is used for loading the first input term x₁ to said processor and updating a register with said first input term x₁, optionally using said at least one further register.

6. The method of claim 4, wherein at least one sub-instruction of said parallel instruction is used for loading the twiddle factor tf to said processor and updating a register with said twiddle factor tf, optionally using said at least one further register.

7. The method of claim 4, wherein at least one sub-instruction of said parallel instruction is used for loading the second input term x₀ to said processor and updating a register with said second input term x₀, optionally using said at least one further register.

8. The method of claim 4, wherein at least one sub-instruction of said parallel instruction is used for a complex multiplication of said twiddle factor tf and said first input term x₁ using said multiplication capabilities, thus generating a multiplication value.

9. The method of claim 8, wherein at least one further sub-instruction of said parallel instruction is used for shifting and truncating said multiplication value or said multiplication capabilities automatically include said shifting and truncating, thus generating an adjusted multiplication value, and updating a register with said adjusted multiplication value, optionally using said at least one further register.

10. The method of claim 9, wherein at least one still further sub-instruction of said parallel instruction is used for a complex addition of said adjusted multiplication value and said second term for generating said first output terms X₀ and used for complex subtraction of said adjusted multiplication value from said second term for generating said second output terms X₁ using said complex addition/subtraction capabilities.

11. The method of claim 4, wherein at least one yet further sub-instruction of said parallel instruction is used for storing said first and second output terms X₀ and X₁, and for updating registers with said first and second output terms X₀ and X₁, respectively, optionally using said at least one further register.

12. The method of claim 4, wherein before said adding said parallel instruction, the method further comprises:
adding at least one address register and a corresponding at least one address computation unit to said processor for accessing in a corresponding memory said first input term x₀, said second input term x₁, said twiddle factor tf, said first output term X₀ or said second output terms X₁ during said computing of said fast Fourier transform.

13. A computer program product comprising: a computer readable storage structure embodying computer program code thereon for execution by a computer processor with said computer program code characterized in that it includes instructions for performing the steps of the method of claim 1 indicated as being performed by said processor or contained in said parallel instruction provided to said processor.

14. A processor, having complex multiplication and addition/subtraction capabilities and having enhanced computational capabilities for computing a fast Fourier transform, is characterized in that said enhanced computational capabilities comprise:
at least one further register and at least one further interconnect, for performing FFT butterfly computing of said fast Fourier transform; and
a parallel instruction utilizing said at least one further register and said at least one further interconnect for said computing of said FFT butterfly, thus enhancing said computational capabilities of said processor,
wherein said processor is not dedicated to only said computing of said fast Fourier transform.

15. The processor of claim 14, wherein said processor is a non-parallel processor.

16. The processor of claim 14, wherein said processor is a parallel processor.

17. The processor of claim 14, wherein said FFT butterfly is for calculating first and second output terms X₀ and X₁, respectively, described by equations with complex terms:
$$\{ \begin{matrix}{X}_{0} = {x}_{0} + tf \cdot {x}_{1} \\ {X}_{1} = {x}_{0} - tf \cdot {x}_{1}\end{matrix} ,$$
wherein tf is a twiddle factor, x₁ and x₀ are first and second input terms, respectively, and wherein said twiddle factor tf, said first input term x₁ or said second input term x₀ is loaded to said processor using said at least one further register.

18. The method of claim 17, wherein at least one sub-instruction of said parallel instruction is used for loading the first input term x₁ to said processor and updating a register with said first input term x₁, optionally using said at least one further register.

19. The processor of claim 17, wherein at least one sub-instruction of said parallel instruction is used for loading the twiddle factor tf to said processor and updating a register with said twiddle factor tf, optionally using said at least one further register.

20. The processor of claim 17, wherein at least one sub-instruction of said parallel instruction is used for loading the second input term x₀ to said processor and updating a register with said second input term x₀, optionally using said at least one further register.

21. The processor of claim 17, wherein at least one sub-instruction of said parallel instruction is used for a complex multiplication of said twiddle factor tf and said first input term x₁ using said multiplication capabilities, thus generating a multiplication value.

22. The processor of claim 21, wherein at least one further sub-instruction of said parallel instruction is used for shifting and truncating said multiplication value or said multiplication capabilities automatically include said shifting and truncating, thus generating an adjusted multiplication value, and updating a register with said adjusted multiplication value, optionally using said at least one further register.

23. The processor of claim 22, wherein at least one still further sub-instruction of said parallel instruction is used for a complex addition of said adjusted multiplication value and said second term for generating said first output terms X₀ and used for complex subtraction of said adjusted multiplication value from said second term for generating said second output terms X₁ using said complex addition/subtraction capabilities.

24. The processor of claim 17, wherein at least one yet further sub-instruction of said parallel instruction is used for storing said first and second output terms X₀ and X₁, and for updating registers with said first and second output terms X₀ and X₁, respectively, optionally using said at least one further register.

25. The processor of claim 17, wherein said enhanced computational capabilities further comprise:
at least one address register and a corresponding at least one address computation unit, for accessing in a corresponding memory said first input term x₀, said second input term x₁, said twiddle factor tf, said first output term X₀ or said second output terms X₁ during said computing of said fast Fourier transform.

26. An electronic device having a processor containing complex multiplication and addition/subtraction capabilities and enhanced computational capabilities for computing a fast Fourier transform, is characterized in that said enhanced computational capabilities comprise:
at least one further register and at least one further interconnect, for performing FFT butterfly computing of said fast Fourier transform; and
a parallel instruction utilizing said at least one further register and said at least one further interconnect for said computing of said FFT butterfly, thus enhancing said computational capabilities of said processor,
wherein said processor is not dedicated to only said computing of said fast Fourier transform.

27. The electronic device of claim 26, wherein said processor is a non-parallel processor or a parallel processor.
